(19) United States
(12) Patent Application Publication
(10) Pub. No.: US 2014/0342614 A1
(43) Pub. Date: Nov. 20, 2014

(54) CONNECTOR

(71) Applicant: IRISO ELECTRONICS CO., LTD., Kanagawa (JP)

(72) Inventors: Hiroaki YUKUTAKE, Kanagawa (JP); Hiroaki KOBAYASHI, Kanagawa (JP)

(73) Assignee: IRISO ELECTRONICS CO., LTD., Kanagawa (JP)

(21) Appl. No.: 14/279,854

(22) Filed: May 16, 2014

(30) Foreign Application Priority Data
May 20, 2013 (JP) 2013106599

(51) Int. Cl. H01R 13/46

(52) U.S. Cl. CPC H01R 13/46
USPC 439/626

(57) ABSTRACT

A connector is provided to sufficiently absorb the displacements of a plurality of connection objects with respect to a substrate even when the plurality of connection objects are connected. Two movable housings are formed by separate members that can move relative to each other, thereby absorbing the displacements of two mating connectors connected to the respective movable housings by each of the respective movable housings. This can sufficiently absorb the displacements of the mating connectors relative to a substrate.

### BACKGROUND OF THE INVENTION

1. Field of the Invention

The present invention relates to connectors mounted on, for example, circuit boards for various electrical appliances so as to be connected to the terminals of mating connectors.

2. Description of the Related Art

Such a conventionally known connector includes a stationary housing fixed to a substrate, a movable housing that is movably provided relative to the stationary housing and accommodates a connection object inserted from one end of the movable housing, and a plurality of terminals, each being disposed with one end held by the movable housing and the other end held by the stationary housing. The connector allows the connection object inserted into the movable housing to come into contact with one end of the terminal while causing elastic deformation of the terminals to accept a movement of the movable housing with respect to the stationary housing (for example, Japanese Patent Publication No. 2007-18785).

In some cases, the connector is connected to a plurality of mating connectors, each including at least one mating terminal. In the case of the connector, however, the mating connectors are connected to the single movable housing. Thus, for example, even if only some of the mating connectors are displaced from the connector or the mating connectors are displaced in different directions to each other, the movable housing cannot move with all the mating connectors and thus cannot sufficiently absorb the displacements of the mating connectors under vibrations or an impact.

### BRIEF SUMMARY OF THE INVENTION

The present invention has been devised in view of the problem. An object of the present invention is to provide a connector that can sufficiently absorb the displacements of a plurality of connection objects with respect to a substrate even when the plurality of connection objects are connected.

In order to attain the object, the present invention provides a connector including: a stationary housing fixed to a substrate; at least one movable housing that is movably provided relative to the stationary housing and allows the insertion of a connection object from one end of the movable housing; and a plurality of terminals, each being disposed with one end held by the movable housing and the other end held by the stationary housing, the connector allowing the connection object inserted into the movable housing to come into contact with one end of the terminal while causing elastic deformation of the terminals to accept a movement of the movable housing with respect to the stationary housing, the at least one movable housing including multiple movable housings, the movable housings being formed by separate members that are capable of moving relative to each other.

Thus, when a plurality of connection objects are connected, the connection objects are connected to the movable housings, and if the substrate and the connection objects are displaced from each other under vibrations or an impact, the elastic deformation of the terminals accepts the movements of the movable housings, allowing the movable housings to separately absorb the displacements of the connection objects.

According to the present invention, even if a plurality of connection objects are connected, the displacements of the connection objects connected to the movable housings can be separately absorbed by the movable housings, thereby sufficiently absorbing the displacements of the connection objects relative to the substrate. The present invention is quite useful for vehicle-installed electrical appliances used under large vibrations or a large impact.

### BRIEF DESCRIPTION OF SEVERAL VIEWS OF THE DRAWINGS

FIG. 1 is a front perspective view of a connector according to an embodiment of the present invention;

FIG. 2 is a rear perspective view of the connector;

FIG. 3 is a front view of the connector;

FIG. 4 is a rear view of the connector;

FIG. 5 is a plan view of the connector;

FIG. 6 is a rear view of the connector;

FIG. 7 is a side view of the connector;

FIG. 8 is a cross-sectional view taken along line I-I of FIG. 5;

FIG. 9 is a perspective view of a terminal;

FIG. 10 is a cross-sectional view of a side of the connector with a connected mating connector; and

FIG. 11 is a perspective view of the connector and the mating connectors.

### DETAILED DESCRIPTION OF THE INVENTION

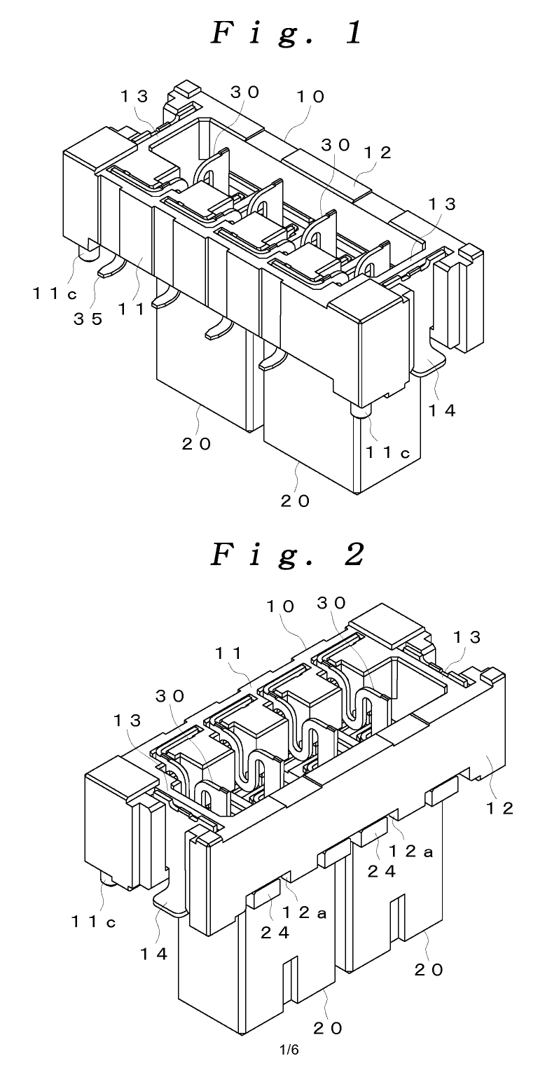

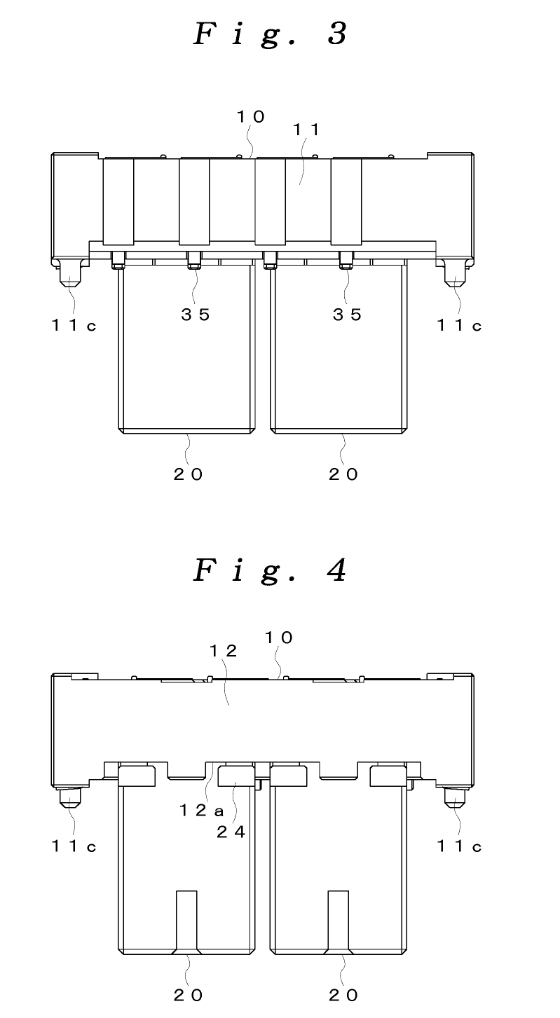

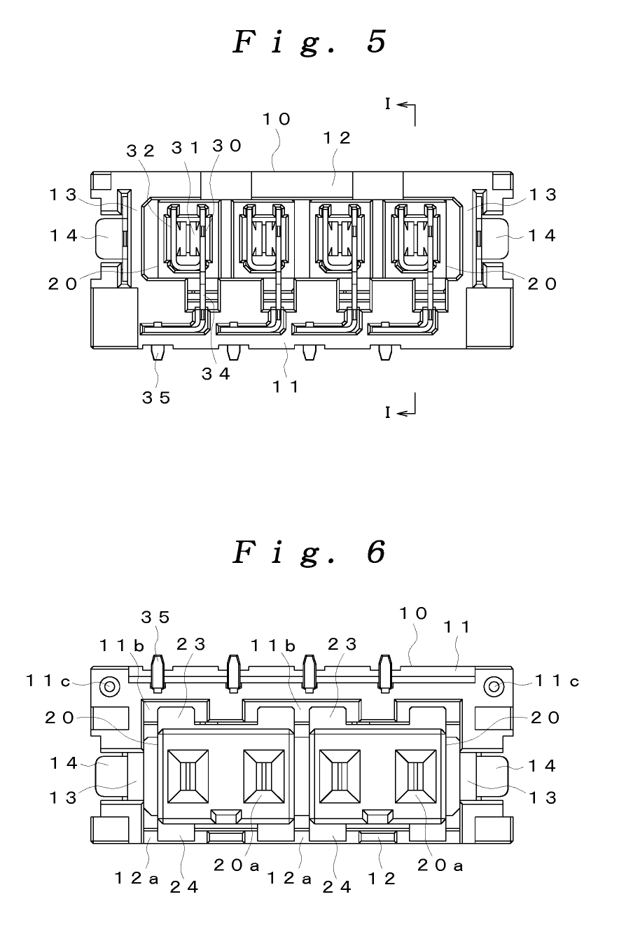

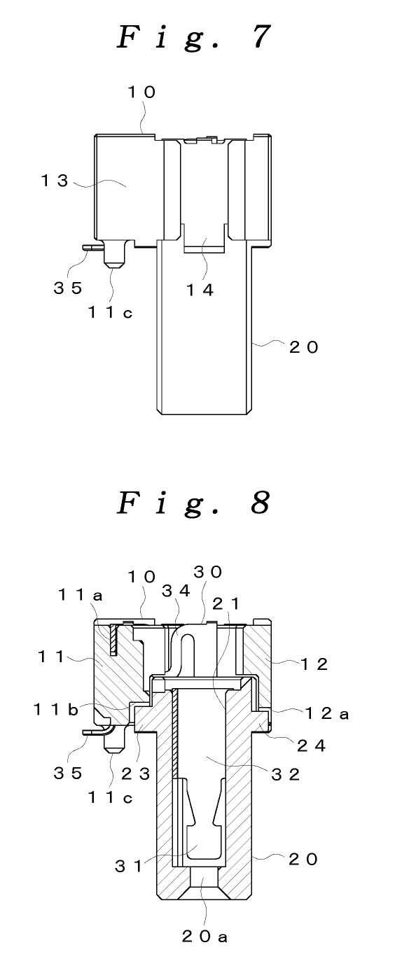

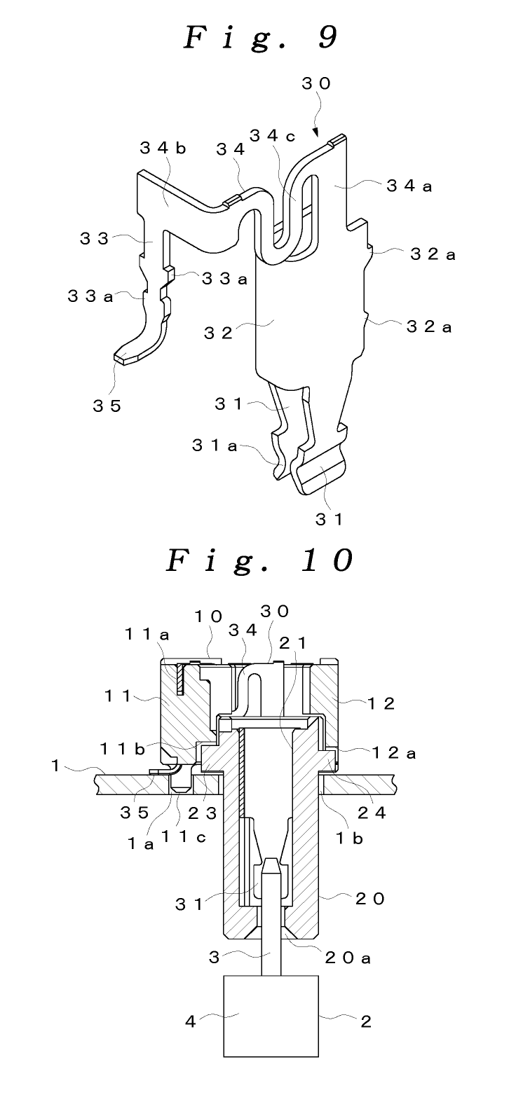

FIGS. 1 to 11 show a connector mounted on circuit boards for various electrical appliances according to an embodiment of the present invention.

The connector is mounted on a substrate 1 and is connected to a plurality of mating connectors 2 serving as connection objects. The mating connector 2 includes two pin-type mating terminals 3 held by an insulating member 4.

The connector according to the present embodiment includes a stationary housing 10 where the mating terminals 3 are inserted from the bottom, two movable housings 20 provided so as to move in a longitudinal direction (X direction), a width direction (Y direction), and a vertical direction (Z direction) with respect to the stationary housing 10, and four terminals 30, each being disposed with one end held by the movable housing 20 and the other end held by the stationary housing 10. The terminals 30 are spaced in the width direction of the stationary housing 10.

The stationary housing 10 is a molded article of synthetic resin. The stationary housing 10 is longer in the width direction than in the longitudinal direction. The stationary housing 10 is a hollow body surrounded by a front part 11, a rear part 12, and left and right side parts 13. The top surface and undersurface of the stationary housing 10 are opened above and below. The front part 11 has four terminal grooves 11a, each holding the other end of the terminal 30 so as to press the other end of the terminal 30 into the terminal groove 11a. The lower end of the front part 11 and the lower end of the rear part 12 are respectively provided with a first concave portion 11b and a second concave portion 12a that are in contact with the movable housings 20. Furthermore, protrusions 11c for positioning the front part 11 relative to the substrate 1 are provided on both ends in the width direction of the undersurface of the front part 11. Moreover, the side parts 13 each have a metallic fixing member 14 for fixing the stationary housing 10 to the substrate 1.

The movable housings 20 are molded articles that are made of synthetic resin and are identical in shape. The movable housings 20 are formed by separate members relatively movable to each other. Furthermore, the movable housing 20 is shaped like a rectangular parallelepiped that is longer in the vertical direction than in the longitudinal and width directions and is disposed on a lower part in the stationary housing 10 so as to move in the longitudinal, width, and vertical directions. The movable housing 20 has two terminal holes 21, each holding one end of the terminal 30. One end of the terminal 30 is pressed into the terminal hole 21 so as to be fixed to the movable housing 20. The undersurface of the movable housing 20 has two insertion openings 22 where the mating terminals 3 are inserted. An opening of the insertion openings 22 gradually expand downward. A pair of first protrusions 23 protruding forward are spaced in the width direction on the upper part of the front of the movable housing 20. The first protrusion 23 moves upward into contact with the upper end face of the first concave portion 11b of the stationary housing 10. Moreover, a pair of second protrusions 24 protruding rearward are spaced in the width direction on the upper part of the rear of the movable housing 20. The second protrusions 24 move upward into contact with the upper end face of the second concave portion 12a of the stationary housing 10.

The terminals 30 are formed by punching and bending of a metallic plate and are spaced in the width direction. The terminal 30 includes a pair of contact portions 31 in contact with the mating terminals 3, a first fixed portion 32 fixed in the movable housing 20, a second fixed portion 33 fixed in the stationary housing 10, a movable portion 34 that is an elastically deformable portion formed between the first fixed portion 32 and the second fixed portion 33, and a substrate joint 35 connected to the substrate 1.

The contact portions 31 are provided on one end of the terminal 30 and are formed to oppose to each other in the width direction of the terminal 30. The contact portions 31 are formed so as to elastically deform in the width direction of the terminal 30. The mating terminal 3 is pressed between contact portions 31a that are formed in a shape protruding toward each other.

The first fixed portion 32 is provided on one end of the terminal 30 and is held by the movable housing 20. The first fixed portion 32 is substantially shaped like a letter U that is opened at the rear end of the terminal, and the contact portions 31 are extended below from the lower ends of the side parts. Locking portions 32a locked to the internal surface of the terminal hole 21 of the movable housing 20 protrude at the rear ends of the side parts of the first fixed portion 32. The first fixed portion 32 is pressed into the terminal hole 21 so as to lock the locking portions 32a, thereby fixing the first fixed portion 32 into the movable housing 20.

The second fixed portion 33 is provided on the other end of the terminal 30 and is held by the stationary housing 10. The second fixed portion 33 is formed to vertically extend and has locking portions 33a that protrude on both ends in the width direction of the second fixed portion 33 so as to be locked into the terminal groove 11a of the stationary housing 10. In other words, the second fixed portion 33 is pressed into the terminal groove 11a so as to lock the locking portion 33a. Thus, the second fixed portion 33 is fixed to the stationary housing 10.

The movable portion 34 includes a first elastic piece 34a extending upward from the first fixed portion 32, a second elastic piece 34b extending from the upper end of the second fixed portion 33 in the width direction of the terminal 30, and a third elastic piece 34c that is formed to be substantially bent like a letter U between the first elastic piece 34a and the second elastic piece 34b. The movable portion 34 is elastically deformed in the longitudinal, width, and vertical directions by the elastic pieces 34a, 34b, and 34c.

The substrate joint 35 is formed so as to extend from the lower end of the second fixed portion 33 to the front of the terminal 30. The end of the substrate joint 35 is formed to gradually decrease in width toward the front of the terminal 30.

The connector configured thus is disposed on the top surface (one surface) of the substrate 1. The fixing members 14 of the stationary housing 10 and the substrate joints 35 of the terminals 30 are soldered to the substrate 1, thereby fixing the connector to the substrate 1. At this point, the protrusions 11c of the stationary housing 10 are engaged with positioning holes 1a provided on the substrate 1; meanwhile, the lower ends of the movable housings 20 are inserted into openings 1b provided on the substrate 1. The opening 1b is formed to be slightly larger than the outer periphery of the movable housing 20. The first and second protrusions 23 and 24 of the movable housings 20 are disposed between the top surface of the substrate 1 and the first and second concave portions 11b and 12a of the stationary housing 10. In this case, the vertical size of the first protrusion 23 is formed to be smaller than a height from the top surface of the substrate 1 to the upper end face of the first concave portion 11b while the vertical size of the second protrusion 24 is formed to be smaller than a height from the top surface of the substrate 1 to the upper end face of the second concave portion 12a.

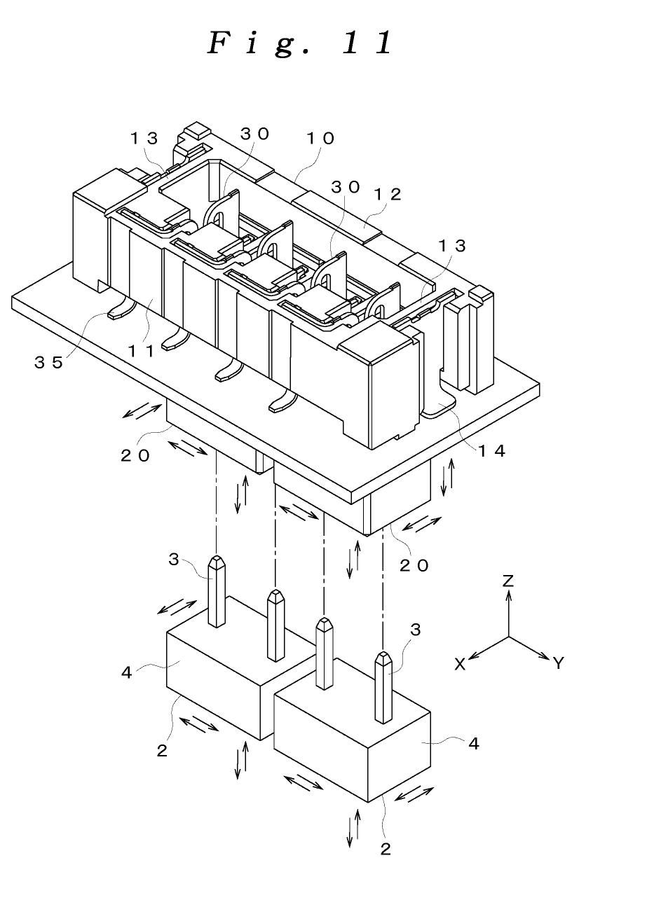

Subsequently, when the mating connectors 2 are connected to the connector, one of the mating connectors 2 is connected to one of the movable housings 20 while the other mating connector 2 is connected to the other movable housing 20. Specifically, as shown in FIG. 10, the mating terminals 3 of the mating connectors 2 are inserted into the insertion openings 20a of the movable housings 20 from below the substrate 1, connecting the mating terminals 3 to the terminals 30 in the movable housings 20. At this point, the mating terminals 3 inserted into the movable housings 20 are held by the contact portions 31a of the contact portions 31 while pressing the contact portions 31 of the terminals 30 to the outside. The contact portions 31a pressed into contact with the mating terminals 3 connect the mating terminals 3 and the terminals 30. When the mating terminals 3 are pressed between the contact portions 31, the movable portions 34 of the terminals 30 are elastically deformed so as to move the movable housings 20 upward. The first and second protrusions 23 and 24 are brought in contact with the first and second concave portions 11b and 12a of the stationary housing 10, regulating an upward movement of the movable housings 20. This does not excessively cause upward elastic deformation on the movable portions 34 of the terminals 30.

In the connected condition, if the substrate 1 and the mating connectors 2 are displaced from each other by vibrations or an impact, a movement of the movable housing 20 is accepted by the elastic deformation of the movable portions 34 of the terminals 30 so as to absorb the displacement. At this point, for example, if only some of the mating connectors 2 are displaced from the substrate 1 or the mating connectors 2 are displaced in different directions to each other, the movable housings 20 move with the mating connectors 2 so as to absorb the displacements of the respective mating connectors 2 by the respective movable housings 20.

When the mating connectors 2 are disconnected, the mating terminals 3 are pulled out of the terminals 30, elastically deforming the movable portions 34 of the terminals 30 so as to move the movable housings 20 downward. The first and second protrusions 23 and 24 in contact with the top surface of the substrate 1 regulate a downward movement of the movable housings 20. This does not excessively cause downward elastic deformation on the movable portions 34 of the terminals 30.

Thus, according to the present embodiment, the provided two movable housings 20 are formed by separate members that can move relative to each other. Thus, the displacements of the two mating connectors 2 connected to the movable housings 20 can be absorbed by the respective movable housings 20, thereby sufficiently absorbing the displacements of the mating connectors 2 relative to the substrate 1.

Moreover, the first and second protrusions 23 and 24 of the movable housings 20 are disposed between the top surface of the substrate 1 and the first and second concave portions 11b and 12a of the stationary housing 10. Thus, the movable housing 20 is configured such that an upward (one inserting/removing direction) movement of the mating terminal 3 is regulated at a predetermined position by the first and second concave portions 11b and 12a of the stationary housing 10 while a downward (the other inserting/removing direction) movement of the mating terminal 3 is regulated at another predetermined position by one surface of the substrate 1. When the mating terminal 3 is inserted or removed, the movable portion 34 of the terminal 30 does not undergoes excessive elastic deformation in the inserting/removing direction. This can reliably insert and remove the mating terminal 3 and prevent plastic deformation on the movable portion 34 of the terminal 30.

In the present embodiment, the two movable housings 20 are provided so as to move relative to each other. Three or more movable housings may be provided.

In the present embodiment, the mating terminals 3 are inserted into the movable housings 20 from below. The mating terminals 3 may be inserted from above.

1. A connector comprising:
a stationary housing fixed to a substrate;
at least one movable housing that is movably provided relative to the stationary housing and allows insertion of a connection object from one end of the movable housing;
and a plurality of terminals, each being disposed with one end held by the movable housing and the other end held by the stationary housing, the connector allowing configured to allow the connection object inserted into the movable housing to come into contact with one end of the terminal while causing elastic deformation of the terminals to accept a movement of the movable housing with respect to the stationary housing,
the at least one movable housing comprising multiple movable housings,
the movable housings being formed by comprising separate members that are capable of moving relative to each other.

2. The connector according to claim 1, wherein the movable housing is configured such that a movement of the connection object in one inserting/removing direction is regulated at a predetermined position by the stationary housing while a movement of the connection object in the other inserting/removing direction is regulated at another predetermined position by one surface of the substrate.
